(19) United States
(12) Patent Application Publication
(10) Pub. No.: US 2009/0066279 A1
(43) Pub. Date: Mar. 12, 2009

(54) Thin sensorless multiphase DC motor for rotating display unit

(75) Inventors: Edward Lopatinsky, (US); Daniel Schaefer, (US)

Correspondence Address: Industrial Design Laboratories, Inc, Suite 307, 5450 Complex Street, San Diego, CA, 92123, US

(73) Assignee: Industrial Design Laboratories, Inc

(21) Appl. No.: 12/231,650

(22) Filed: Sep. 4, 2008

Related U.S. Application Data
(60) Provisional application No. 60/967,684, filed on Sep. 6, 2007.

(51) Int. Cl. H02P 6/08

(52) U.S. Cl. 318/400.42

(57) ABSTRACT

A thin sensorless multiphase DC motor for rotating display unit comprises a flat stator, a flat magnetized rotor, an axle, a power source and multiphase electronic controller. The flat stator located parallel to the flat magnetized rotor and comprises circumferentially arrayed coils with magnetic axes parallel to the axle. The magnetized rotor comprises a display disk and located at the periphery of the display disk circumferentially arrayed permanent magnets with magnetic axes parallel to the magnetic axes of the coils. The electronic controller comprises logic elements, phase drivers and a frequency generator.

### CROSS REFERENCE TO RELATED APPLICATIONS

The present application claims the benefit of priority of U.S. Provisional Patent Application No. 60/967,684, filed Sep. 6, 2007 for Edward Lopatinsky at al. the entire content of which is incorporated herein by reference.

### FIELD OF THE INVENTION

The present invention relates generally to promotional and advertising industries. More particularly, the present invention relates to cordless, thin shape, small lightweight, movable display unit that can be installed in a wide range location and can perform intelligent control of rotation easily. The present invention is particularly, but not exclusively, useful for rotating display systems attractively providing promotional information. The present invention can be also useful for toy industry.

### BACKGROUND OF THE INVENTION

In the conventional display unit, most motors used are electromagnetic motors of DC or AC, generally. These electromagnetic motors usually have the high rotational speed and needed in addition a moderation device with a gearing etc. to drive at the lower rate of 200 or less rpm; control units, such as sensors, are required for the rotation position control. For this reason, generally, the limitation is in thin shaped casing, and such display units become large sized. These known designs realize the indirect rotating display units that are complicated, expensive and can not provide the thin design of movable display units.

It is known the solution described in Japanese Patent JP6337645 “Movable Display Device and its Use Method” that employs miniature rotary ultrasonic piezoelectric motor. Such design allows realizing a thin size rotatable display unit. But, this relatively exotic motor design, used in very specific applications at very low temperatures and pressures mainly, is expensive and not enough reliable.

But, experiments have shown that such motor can sustain at least 230 temperature cycles from 0° C. to −90° C. only (Complete Modeling of Rotary Ultrasonic Motors Actuated By Traveling Flexural Waves. Proceedings of SPIE's 7th Annual International Symposium on Smart Structures and Materials, 1-5 Mar. 2000, Newport, Calif. Paper No. 3992-103).

It would be desirable to provide a design of thin sensorless multiphase Direct Current motor for direct rotating display that overcomes the problems associated with high cost and low reliability of known ultrasonic motors.

### SUMMARY OF THE INVENTION

Accordingly, it is an object of the present invention to provide a thin sensorless multiphase DC motor for rotating display unit that is capable of significantly improving display unit performances such as increasing reliability at lower cost.

In order to achieve this object, a thin sensorless multiphase DC motor for rotating display unit comprises a flat stator, a flat magnetized rotor, an axle, a power source and multiphase electronic controller. The flat stator located parallel to the flat magnetized rotor and comprises circumferentially arrayed coils with magnetic axes parallel to the axle. The magnetized rotor comprises a display disk and located at the periphery of the display disk circumferentially arrayed permanent magnets with magnetic axes parallel to the magnetic axes of the coils. The electronic controller comprises logic elements, phase drivers and a frequency generator.

According to the preferable embodiment the multiphase electronic controller operates as three phase electronic controller. The power source may comprise of at least one button cell. The circumferentially arrayed coils may comprise at least three coreless windings located on a printed circuit board or the circumferentially arrayed permanent magnets may comprise at least two permanent magnets integrated with the display disk.

The display disk may be made as a plate shaped disk thus the central part of the plate shaped disk spaced aside from the flat stator and the electronic controller may be at least partially placed on the flat stator from the side close to the plate shaped display disk. The electronic controller at least partially may be placed on the flat stator from the side close to the plate shaped display disk. The button cell also may be placed on the flat stator from the side close to the plate shaped disk.

The electronic controller may further comprise a voltage ramp generator and circumferentially arrayed coils may be etched on a printed circuit board.

The foregoing and other objectives, features and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a front view showing the rotating display unit according to the present invention when the cover has a round shaped display window.

FIG. 2 is a front view showing the rotating display unit according to the present invention when the cover has a semi-round shaped display window.

FIG. 3 is a front view showing the rotating display unit according to the present invention when the cover is removed and the circumferentially arrayed coils comprises at least three coreless windings.

FIG. 4 is a front view showing the rotating display unit according to the present invention when the cover is removed and the circumferentially arrayed permanent magnets comprises at least two permanent magnets.

FIG. 5 is a top sectional view showing the rotating display unit according to the present invention when the display disk is made as a plate shaped disk.

FIG. 5A is a front view showing the rotating display unit of FIG. 5 according to the present invention when the cover is removed.

FIG. 6 is a front view showing the flat magnetized rotor according to the present invention.

FIG. 7 is a top sectional view showing the rotating display unit according to the present invention when the circumferentially arrayed coils comprises at least three coreless windings.

FIG. 7A is a top sectional view showing the rotating display unit according to the present invention when the circumferentially arrayed coils are etched on a printed circuit board.

### DETAILED DESCRIPTION OF THE INVENTION

Preferred embodiment of the present invention will be described in detail below with reference to the accompanying drawings.

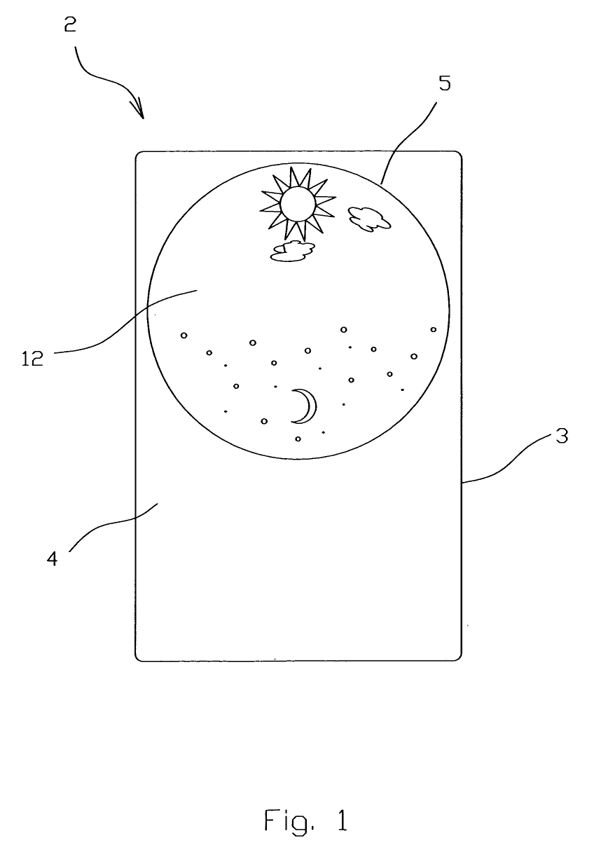

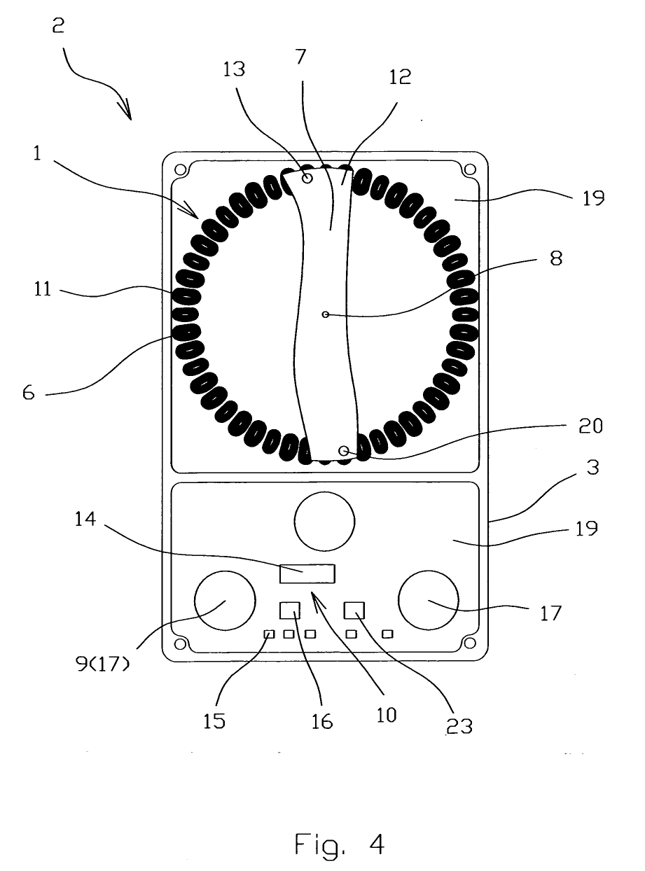

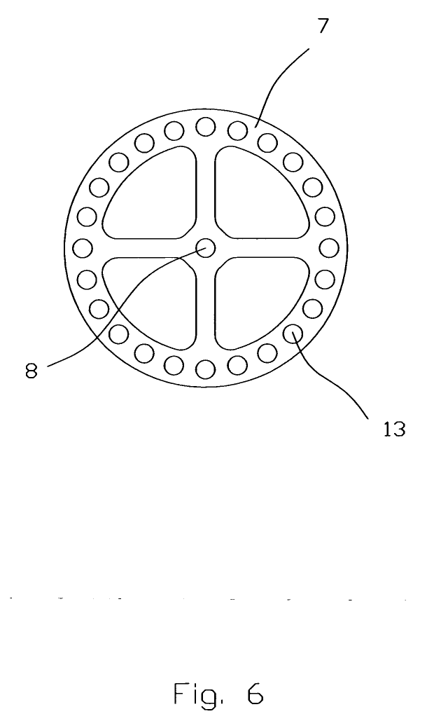

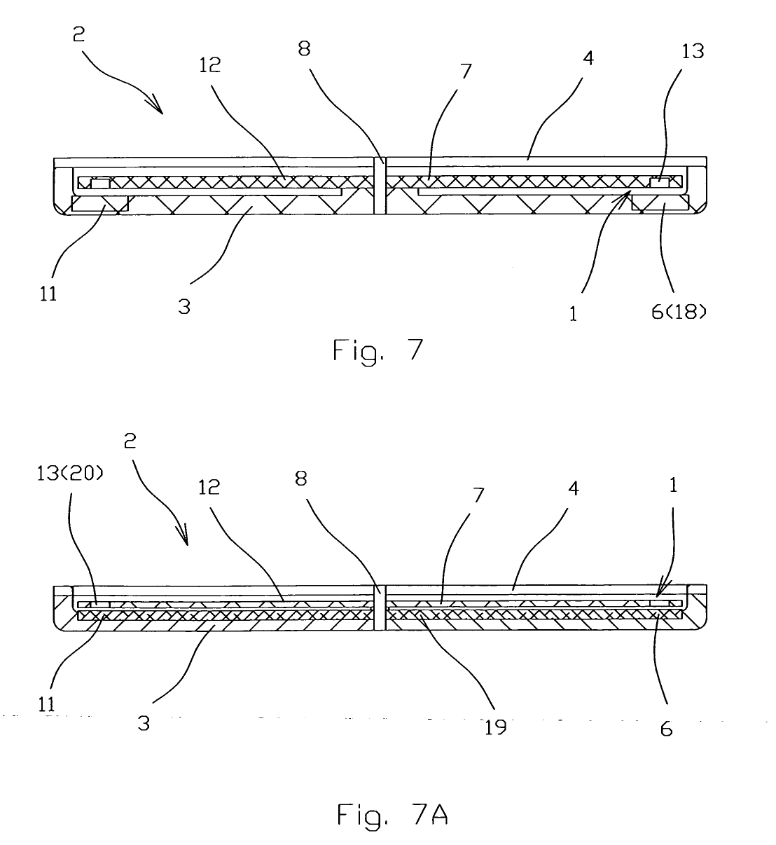

FIGS. 1-7A show embodiments of the present invention.

The thin sensorless multiphase DC motor 1 for rotating display unit 2 comprises the flat stator 6, the flat magnetized rotor 7, the axle 8, the power source 9 and the multiphase electronic controller 10. The flat stator 6 located parallel to the flat magnetized rotor 7 and comprises circumferentially arrayed coils 11 with magnetic axes parallel to the axle 8. The magnetized rotor 7 comprises the display disk 12 and located at the periphery of the display disk 12 the circumferentially arrayed permanent magnets 13 with magnetic axes parallel to the magnetic axes of the coils 11. The electronic controller 10 comprises the logic elements 14, the phase drivers 15 and the frequency generator 16.

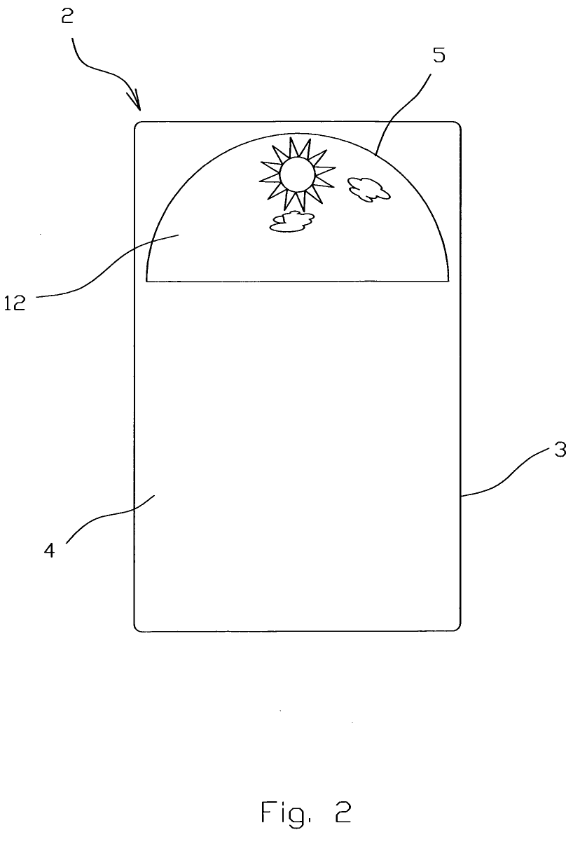

The thin sensorless multiphase DC motor 1 located inside the direct rotating display unit 2 comprises the casing 3 and the cover 4 with the display window 5. The flat stator 6 integrated with the inner surface of the casing 3 while the flat magnetized rotor 7 placed at the axle 8 with the possibility of rotation thus the display disk 12 at least partially can be observed through the display window 5. The display window 5 can be made as a round shaped display window 5 (FIG. 1) or as a semi-round shaped display window 5 (FIG. 2).

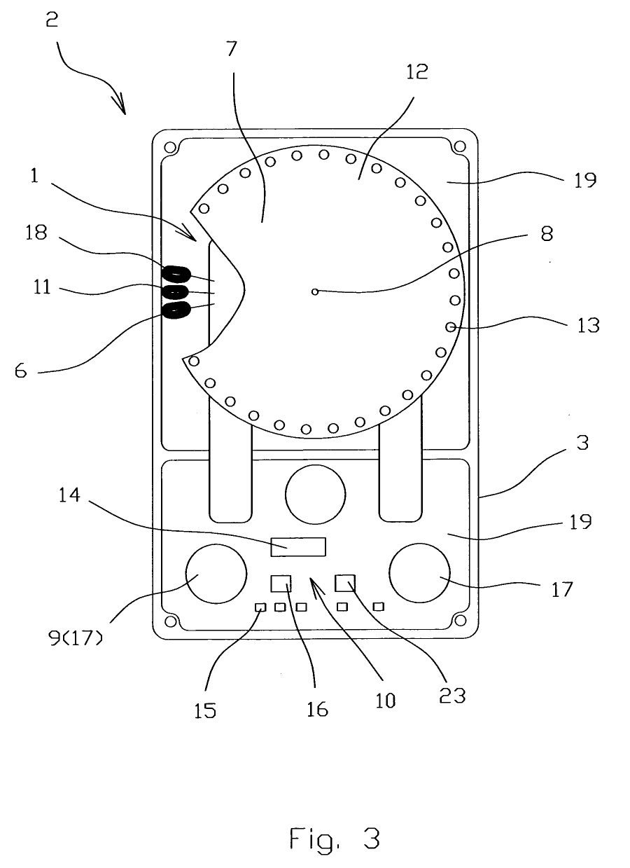

According to the preferred embodiment the multiphase electronic controller 10 operates as three phase electronic controller. The power source 9 may comprise of at least one button cell 17. The circumferentially arrayed coils 11 comprises at least three coreless windings 18 located on a printed circuit board 19 (FIGS. 3, 5A and 7).

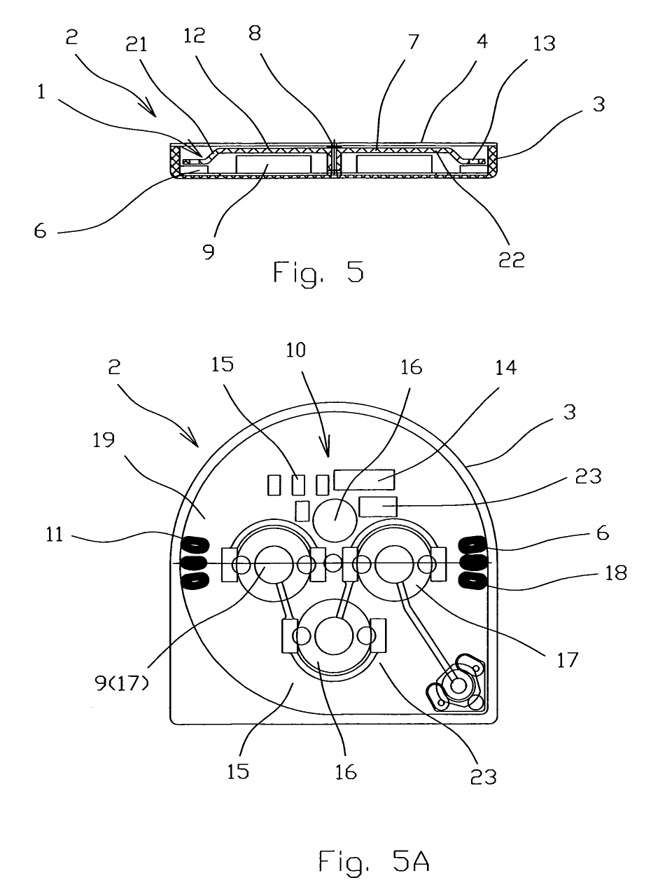

According to another embodiment the circumferentially arrayed permanent magnets 13 may comprise at least two permanent magnets 20 integrated with the display disk 12. The display disk 12 may be made as a plate shaped disk 21 thus the central part 22 of the plate shaped disk 21 spaced aside from the flat stator 6 (FIG. 5) and the multiphase electronic controller 10 and power source 9 are placed into the space between the plate shaped disk 21 and the flat stator 6. In that case the overage size of the rotating display unit 2 can be considerably decreased. The electronic controller 10 may further comprise the voltage ramp generator 23 providing smooth and easy start of the thin sensorless multiphase DC motor 1.

The thin sensorless multiphase DC motor 1 for rotating display unit 2 operates in the following way. When an electric power supplied to the flat stator 6, the alternative electro-magnetic field is created. This electro-magnetic field controlled by the controller 10 interacts with a magnetic field created by the flat magnetized rotor 7. In result of this interaction the magnetized rotor 7 and, therefore the display disk 12 starts to rotate.

As a result, the proposed thin sensorless multiphase DC motor 1 for rotating display unit 2 provides directly smooth, stable low RPM and solves problems associated with large size, high cost and low reliability of known ultrasonic motors.

What is claimed is:

1. A thin sensorless multiphase DC motor for rotating display unit comprising a flat stator, a flat magnetized rotor, an axle, a power source and multiphase electronic controller, wherein:
(i) said flat stator located parallel to said flat magnetized rotor and comprises circumferentially arrayed coils with magnetic axes parallel to said axle;
(ii) said magnetized rotor comprises a display disk and located at the periphery of said display disk circumferentially arrayed permanent magnets with magnetic axes parallel to the magnetic axes of said coils;
(iii) said electronic controller comprises logic elements, phase drivers and a frequency generator.

2. The DC motor as claimed in claim 1, wherein said multiphase electronic controller operates as three phase electronic controller.

3. The DC motor as claimed in claim 1, wherein said power source comprises of at least one button cell.

4. The DC motor as claimed in claim 1, wherein said circumferentially arrayed coils comprises at least three coreless windings located on a printed circuit board.

5. The DC motor as claimed in claim 1, wherein said circumferentially arrayed permanent magnets comprises at least two permanent magnets integrated with said display disk.

6. The DC motor as claimed in claim 1, wherein said display disk is made as a plate shaped disk thus the central part of said plate shaped disk spaced aside from said flat stator.

7. The DC motor as claimed in claim 6, wherein said electronic controller at least partially placed on said flat stator from the side close to said plate shaped display disk.

8. The DC motor as claimed in claim 3 and 6, wherein said button cell placed on said flat stator from the side close to said plate shaped disk.

9. The DC motor as claimed in claim 1, wherein said electronic controller further comprises a voltage ramp generator.

10. The DC motor as claimed in claim 1, wherein said circumferentially arrayed coils are etched on a printed circuit board.
